(19) United States
(12) Patent Application Publication
(10) Pub. No.: US 2008/0105759 A1
(43) Pub. Date: May 8, 2008

(54) Beverage fountain

(76) Inventor: Kam-Lai Wong, Hong Kong (CN)

Correspondence Address: ALIX YALE & RISTAS LLP, 750 MAIN STREET, SUITE 1400, HARTFORD, CT, 06103, US

(21) Appl. No.: 11/544,094

(22) Filed: Oct. 6, 2006

(51) Int. Cl. B05B 17/04

(52) U.S. Cl. 239/12

(57) ABSTRACT

A beverage fountain includes a reservoir for containing a low-viscosity liquid. A riser tube extends upwardly from the reservoir. A pump pumps liquid from the reservoir upwardly through the riser tube. A weir at an upper part of the riser tube has a peripheral array of drains past which individual streams of liquid flow for return to the reservoir and possible interception by a drinking vessel.

### BACKGROUND OF THE INVENTION

The present invention relates to fountains for liquid beverages such as champagne, fruit punch, fruit juice, cordials or the like. More particularly, although not exclusively, the invention relates to such a fountain of a style that might be used in the home to entertain party guests, or in hotel dining rooms, restaurants or buffets for example.

Known multi-tier food fountains are designed for use with viscous substances such as chocolate fondue or syrup-like substances and comprise a bowl from which a vertical riser tube extends and in which a slow-turning auger is rotated by a motor to draw the substance from the bowl to an outlet at the top of the riser tube. From the top of the riser tube, the viscous substance flows over a mushroam-shaped surface to fall in a continuous cylindrical sheet to a second, larger mushroom-shaped surface, from which a larger-diameter continuous cylindrical sheet of viscous material cascades.

Such fountains as described above are limited to use with viscous substances into which a food item such as a strawberry for example can be dipped prior to consumption. The slow-turning auger cannot draw a fast-flowing low-viscosity liquid intended to be imbibed from a glass or cup for example. Furthermore, since drinking vessels cannot be inverted and dipped in any sensible or sanitary manner into the liquid for the purpose of filling, they must be filled from above. Placing an upright glass for example into a cylindrical sheet-like flow of liquid would be untidy as liquid would inevitably mess the outside surface of the glass.

### OBJECT OF THE INVENTION

It is an object of the present invention to overcome or substantially ameliorate it least one of the above disadvantages and/or more generally to provide an improved beverage fountain.

### DISCLOSURE OF THE INVENTION

There is disclosed herein a beverage fountain, comprising:
a reservoir for containing a low-viscosity liquid,
a riser tube extending upwardly from the reservoir,
a pump for pumping liquid from the reservoir upwardly through the riser tube, and
an upper weir receiving liquid from the riser tube and comprising an array of drains past which individual streams of liquid flow for return to the reservoir and possible interception by a drinking vessel en route thereto.

Preferably, the upper weir has a continuous periphery at or alongside which the array of drains is situated.

Preferably, each drain comprises a hole.

Preferably, each drain comprises a short tube.

Preferably, the upper weir comprises an inverted hollow cone for attachment to the riser tube and through which the liquid from the riser tube passes.

Preferably, the fountain further comprises a housing containing the pump and comprising an inlet through which liquid from the reservoir is drawn by the pump, and further comprising a hopper attached to the housing for directing caught liquid to the inlet.

Preferably, the hopper is situated in the reservoir and comprises a number of apertures through which liquid can pass between the reservoir and the hopper.

Preferably, the fountain further comprises a light source directing light at parts selected from the group consisting of said: riser tube; weir and reservoir.

Preferably, said parts are formed substantially of light transmissive material.

Preferably, said parts are coloured.

Preferably, said light source is coloured.

Preferably, said reservoir rests upon a base including a switch for activating the pump.

Preferably, said reservoir rests upon a base including a switch for activating the light source.

There is further disclosed herein a beverage fountain, comprising:
a reservoir for containing a low-viscosity liquid,
a riser tube extending upwardly from the reservoir,
a pump for pumping liquid from the reservoir upwardly through the riser tube,
an upper weir receiving liquid from the riser tube and comprising a drain past which a stream of liquid flows for return to the reservoir and possible interception by a drinking vessel en route thereto,
an intermediate weir attached to the riser tube below the upper weir for catching said streams of liquid and comprising an intermediate drain past which a stream of caught liquid flows for return to the reservoir and possible interception by a drinking vessel en route thereto, the intermediate weir comprising an intermediate deflector situated above its drain for deflecting liquid from the upper weir toward the riser tube.

Preferably, the intermediate deflector is attached to the intermediate weir by spacers.

Preferably, the intermediate deflector is frustoconical.

Preferably, the fountain further comprises a lower weir attached to the riser tube below the intermediate weir for catching said stream of liquid and comprising a lower drain past which a stream of caught liquid flows for return to the reservoir and possible interception by a drinking vessel en route thereto.

Preferably, the lower weir comprises a lower deflector situated above the lower drain for deflecting liquid from the intermediate weir toward the riser tube.

Preferably, the lower deflector is attached to the lower weir by spacers.

Preferably, the lower deflector is frustoconical.

Preferably, the upper, intermediate and lower weirs each comprise a peripheral lip extending about the respective drains and serving to contain liquid above the drains and a decorative purpose.

There is further disclosed herein a beverage fountain bottom structure, comprising:
a reservoir for containing a low-viscosity liquid,
a pump for pumping liquid from the reservoir,
a housing comprising an inlet through which liquid from the reservoir is drawn by the pump, and
a hopper attached to the housing and situated in the reservoir and comprising an aperture through which liquid can pass between the reservoir and the hopper, wherein the hopper directs liquid returned from said pump to said inlet.

There is further disclosed herein a beverage fountain upper structure, comprising:
a riser tube for passage of liquid upwardly therethrough,
an weir for receiving liquid from the riser tube and comprising a drain past which a stream of liquid falls,
a deflector surrounding the riser tube below the drain for deflecting said stream of liquid toward the riser tube.

Preferably, the deflector is supported by spacers.

Preferably, the deflector is frustoconical.

### BRIEF DESCRIPTION OF THE DRAWINGS

A preferred form of the present invention will now be described by way of example with reference to the accompanying drawings, wherein:

FIG. 1 is a schematic parts-exploded elevation of a beverage fountain,

FIG. 2 is a schematic elevation of the assembled beverage fountain,

FIG. 3 is a schematic perspective illustration of an intermediate weir of the fountain,

FIG. 4 is a schematic perspective illustration of motor and pump housing portions and hopper of the fountain,

FIG. 5 is a schematic elevation of the base and reservoir of the fountain, and

FIG. 6 is a schematic cross-sectional elevation taken at VI-VI in FIG. 5.

### DESCRIPTION OF THE PREFERRED EMBODIMENT

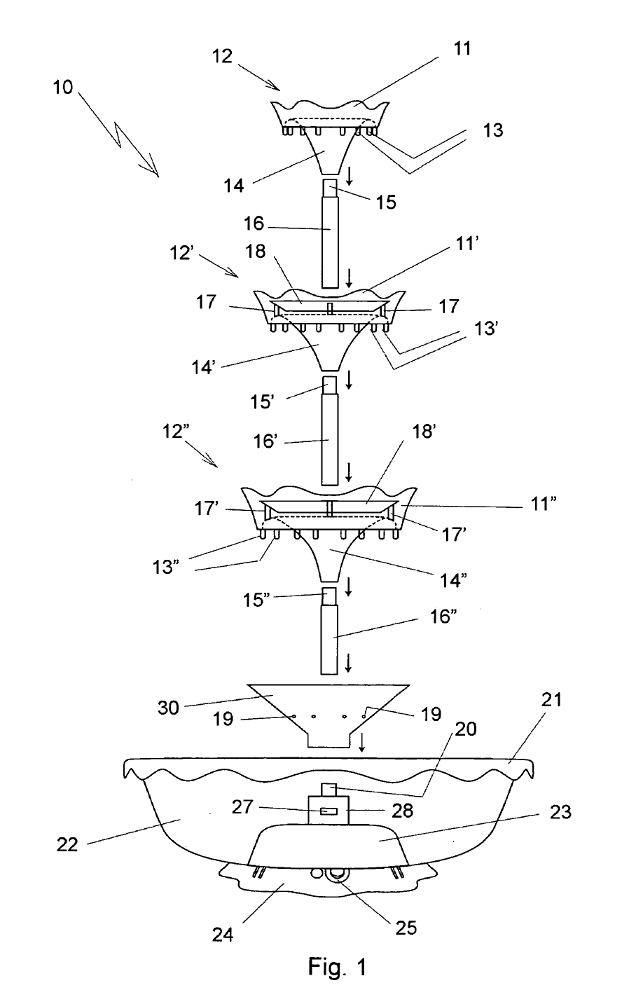

FIG. 1 depicts the major parts forming the structure of a beverage fountain 10. The major parts are typically formed of light-transmissive plastics material such as polycarbonate for example.

The fountain comprises a base 24 having an electrical switch 25 thereon. The base supports a bowl or reservoir 22. Situated within the reservoir there is a motor housing 23 and a pump housing 28. The pump housing 28 comprises an inlet 27 through which liquid from the reservoir 22 is drawn. A socket 20 extends upwardly from the pump housing 28.

A riser tube comprises three individual segments 16, 16′ and 16″. The riser tube segments comprise an upper end socket 15, 15′ and 15″ respectively. The bottom of riser tube segment 16″ fits upon the socket 20. The bottom of riser tube segment 16′ fits upon socket 15″. The bottom of riser tube segment 16 fits upon socket 15′.

Supported upon the riser tube segment 16 is an upper weir 12 having a conical entry passage 14 fitted to the socket 15. The upper weir 12 comprises a peripheral lip 11 inside of and beneath which there is provided a circular array of drain holes 13. Each drain hole 13 takes the form of a short vertical hollow tube.

Fitted upon socket 15′ together with the riser tube segment 16 is an intermediate weir 12′. The intermediate weir 12′ also includes a peripheral lip 11′ and an array of drain holes 13′. These features are similar to those of the upper weir 12, however the diameter of the intermediate weir is greater than that of the upper weir.

The intermediate weir 12′ includes an intermediate inverted hollow cone 14′ at the top of which there is situated a frustoconical intermediate deflector 18. The intermediate deflector 18 is spaced above the inverted cone 14′ by a number of spacers 17. The diameter of the deflector 18 is essentially the same as the diameter of the array of drain holes 13 in the upper weir.

Fitted upon socket 15″ together with the riser tube segment 16′ is a lower weir 12″. The lower weir 12″ also includes a peripheral lip 11″ and an array of drain holes 13″. These features are similar to those of the intermediate weir 12′, however the diameter of the lower weir is greater than that of the intermediate weir. The lower weir 12″ includes a lower inverted hollow cone 14″ at the top of which there is situated a frustoconical lower deflector 18′. The lower deflector 18′ is spaced above the inverted cone 14″ by a number of spacers 17′. The diameter of the lower deflector 18′ is essentially the same as the diameter of the array of drain holes 13′ in the intermediate weir.

Fitted about the pump housing 28 is a conical hopper 30. The upper-most diameter of the hopper 30 is slightly larger than the diameter of the array of holes 13″ in the lower weir. The hopper 30 includes a number of apertures 19.

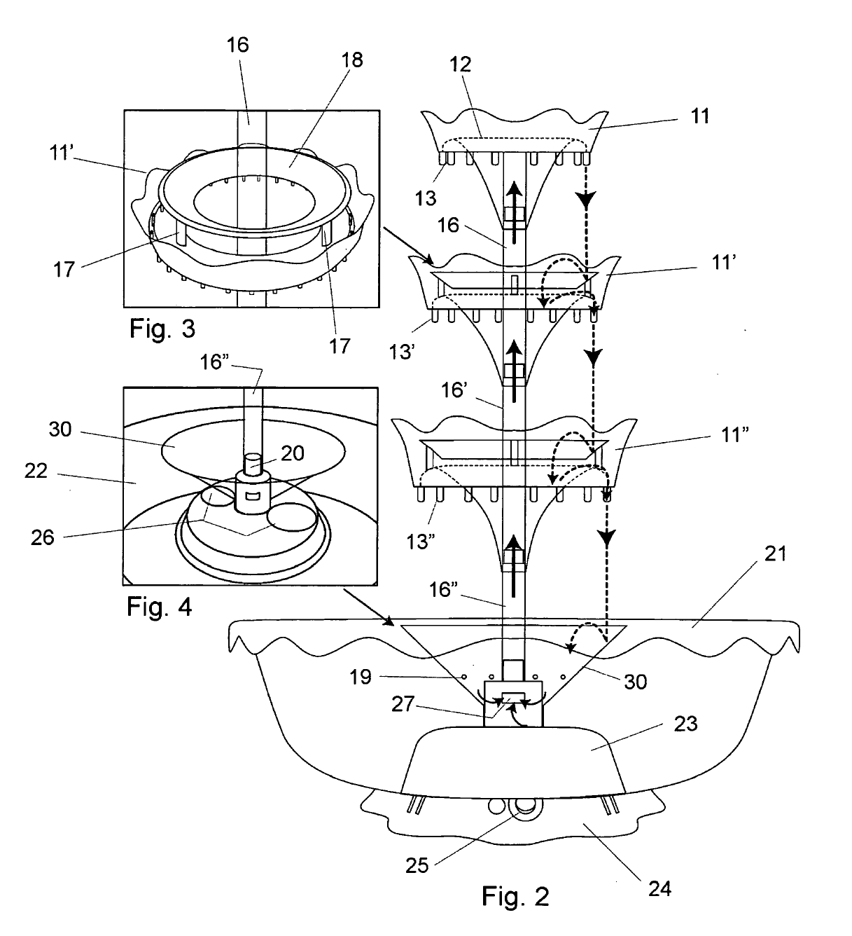

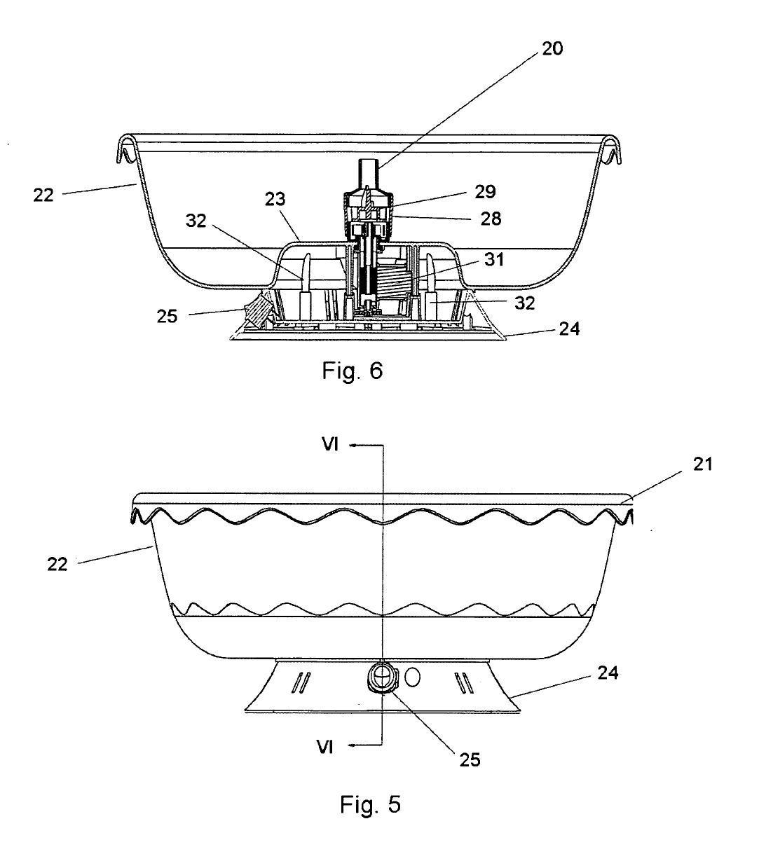

Within the motor housing 23, there is provided an electric/magnetic motor 31 activated by a toggle switch 25 on the base 24. The motor drives a pump impeller 29 located within pump housing 28 to draw in liquid via the inlet 27. This liquid is taken from the reservoir 22 and is forced upwardly through the interconnected riser tube segments by the pump for delivery to the upper weir 12 via its inverted cone 14. The liquid is laterally constrained by the lip 11 and drains from the upper weir via the drain holes 13. This liquid then freefalls as individual separated streams—one of which is indicated by the arrows in FIG. 2. The stream is deflected by the intermediate deflector 18 toward the riser tube segment 16 so that it does not splash outwardly from the intermediate weir. The liquid collects in the intermediate weir and is constrained laterally by the lip 11′. Liquid drains from the intermediate weir via the array of drain holes 13′. This stream is thence deflected by the lower deflector 18′ toward the riser tube segment 16′ so that it does not splash outwardly from the lower weir. The liquid collects in the lower weir and is constrained laterally by the lip 11″. Liquid drains from the lower weir via the array of drain holes 13″ and is received by the hopper 30. The hopper 30 then directs the liquid toward the inlet 27 for recirculation by the pump through the respective riser tube segments. The apertures 19 in the hopper allow liquid from outside the hopper in the reservoir to migrate into the hopper as required.

In order to fill one's glass with liquid beverage, one need simply presented the lip of his or her glass into one of the streams beneath one of the weirs. It is upon such depletion of liquid from the recirculating cascade of liquid that migration of liquid from the reservoir through the apertures 19 takes place. The apertures also serve to enable a back-flow of liquid from the hopper to the reservoir if required.

A pair of lenses 26 is provided in the top surface of the motor housing 23. As shown in FIG. 6, a lamp 31 is situated beneath each lens. The lamps might be activated by the same switch 25 that controls the pump motor. The lenses may be coloured and/or the weirs may be transparent/coloured so that light emanating through the lenses illuminates the fountain most decoratively.

It should be appreciated that modifications and alterations obvious to those skilled in the art are not to be considered as beyond the scope of the present invention. For example, instead of providing a plurality of drain holes, each lip 11, 11′ and 11″ might be provided with open-topped slots or V- or U-shaped trots through which individual streams of liquid can escape.

1. A beverage fountain, comprising:
a reservoir for containing a low-viscosity liquid,
a riser tube extending upwardly from the reservoir,
a pump for pumping liquid from the reservoir upwardly through the riser tube, and
an upper weir receiving liquid from the riser tube and comprising an array of drains past which individual streams of liquid flow for return to the reservoir and possible interception by a drinking vessel en route thereto.

2. The fountain of claim 1, wherein the upper weir has a continuous periphery at or alongside which the array of drains is situated.

3. The fountain of claim 1, wherein each drain comprises a hole.

4. The fountain of claimed 1, wherein each drain comprises a short tube.

5. The fountain of claim 1, wherein the upper weir comprises an inverted hollow cone for attachment to the riser tube and through which the liquid from the riser tube passes.

6. The fountain of claim 1, further comprising a housing containing the pump and comprising an inlet through which liquid from the reservoir is drawn by the pump, and further comprising a hopper attached to the housing for directing caught liquid to the inlet.

7. The fountain of claim 6, wherein the hopper is situated in the reservoir and comprises a nubber of apertures through which liquid can pass between the reservoir and the hopper.

8. The fountain of claim 1, further comprising a light source directing light at parts selected from the group consisting of said: riser tube; weir and reservoir.

9. The fountain of claim 8, wherein said parts are formed substantially of light transmissive material.

10. The fountain of claim 9, wherein said parts are coloured.

11. The fountain of claim 10, wherein said light source is coloured.

12. The fountain of claim 1, wherein said reservoir rests upon a base including a switch for activating the pump.

13. The fountain of claim 1, wherein said reservoir rests upon a base including a switch for activating the light source.

14. A beverage fountain, comprising:
a reservoir for containing a low-viscosity liquid,
a riser tube extending upwardly from the reservoir,
a pump for pumping liquid from the reservoir upwardly through the riser tube,
an upper weir receiving liquid from the riser tube and comprising a drain past which a stream of liquid flows for return to the reservoir and possible interception by a drinking vessel en route thereto,
an intermediate weir attached to the riser tube below the upper weir for catching said stream of liquid and comprising an intermediate drain past which a stream of caught liquid flows for return to the reservoir and possible interception by a drinking vessel en route thereto, the intermediate weir comprising an intermediate deflector situated above its drain for deflecting liquid from the upper weir toward the riser tube.

15. The fountain of claim 14, wherein the intermediate deflector is attached to the intermediate weir by spacers.

16. The fountain of claim 14, wherein the intermediate deflector is frustoconical.

17. The fountain of claim 14, further comprising a lower weir attached to the riser tube below the intermediate weir for catching said stream of liquid and comprising a lower drain past which a stream of caught liquid flows for return to the reservoir and possible interception by a drinking vessel en route thereto.

18. The fountain of claim 17, wherein the lower weir comprises a lower deflector situated above the lower drain for deflecting liquid from the intermediate weir toward the riser tube.

19. The fountain of claim 18, wherein the lower deflector is attached to the lower weir by spacers.

20. The fountain of claim 18, wherein the lower deflector is frustoconical.

21. The fountain of claim 17, wherein the upper, intermediate and lower weirs each comprise a peripheral lip extending about the respective drains and serving to contain liquid above the drains and a decorative purpose.

22. A beverage fountain bottom structure, comprising:
a reservoir for containing a low-viscosity liquid,
a pump for pumping liquid from the reservoir,
a housing comprising an inlet through which liquid from the reservoir is drawn by the pump, and
a hopper attached to the housing and situated in the reservoir and comprising an aperture through which liquid can pass between the reservoir and the hopper, wherein the hopper directs liquid returned from said pump to said inlet.

23. A beverage fountain upper structure, comprising:
a riser tube for passage of liquid upwardly therethrough,
an weir for receiving liquid from the riser tube and comprising a drain past which a stream of liquid falls,
a deflector surrounding the riser tube below the drain for deflecting said stream of liquid toward the riser tube.

24. The upper structure of claim 23, wherein the deflector is supported by spacers.

25. The upper structure of claim 23, wherein the deflector is frustoconical.
